(19) United States
(12) Patent Application Publication
(10) Pub. No.: US 2020/0410423 A1
(43) Pub. Date: Dec. 31, 2020

(54) MINING PROCESS LOGS FOR GENERATION OF WORKFLOW FOR SERVICE REQUEST COMPLETION

(71) Applicant: INTERNATIONAL BUSINESS MACHINES CORPORATION, Armonk, NY (US)

(72) Inventors: Anup KALIA, Yorktown Heights, NY (US); Jin Xiao, Yorktown Heights, NY (US); Maja VUKOVIC, Yorktown Heights, NY (US); Reza Saghafi, Austin, TX (US); Anand Gopalakrishnan, Research Triangle Park, NC (US); Jeffrey Edward Lammers, Cleveland, OH (US)

(21) Appl. No.: 16/452,629

(22) Filed: Jun. 26, 2019

(51) Int. Cl. G06Q 10/06; G06Q 10/10

(52) U.S. Cl. CPC G06Q 10/06316; G06Q 10/10; G06Q 10/06312

(57) ABSTRACT

Generating workflows in response to new service requests. Process logs of different types of prior service requests are mined to extract workflows from the process logs of the prior service requests. The extracted workflows of the prior service requests are saved to a library of workflows. Upon receiving a new service request, one or more workflow recommendations are provided based on one or more of the extracted workflows of the library of workflows. A new workflow is generated for completing the new service request from the one or more workflow recommendations.

### BACKGROUND

The invention relates generally to computer system service requests and, more particularly, to computer systems configured and arranged to mine process logs of prior service requests in response to receiving a new service request.

Today, information technology (IT) professionals deal with many types of IT computer system service requests. Each of these service requests are traditionally handled manually. In particular, each time a new service requested is received, a workflow is manually generated in order to complete the service request.

### SUMMARY

According to a non-limiting embodiment, a computer-implemented method for generating workflows in response to service requests is provided. The method includes mining process logs of different types of prior service requests to extract workflows from the process logs of the prior service requests and saving the extracted workflows of the prior service requests to a library of workflows. The method also includes receiving a new service request and, in response to receiving the new service request, providing one or more workflow recommendations based at least in part on one or more of the extracted workflows of the library of workflows. The method then includes generating a new workflow for completing the new service request from the one or more workflow recommendations.

According to another non-limiting embodiment, a computer system for generating workflows in response to service requests is provided. The computer system includes a processor coupled to a memory unit, wherein the processor is configured to execute program instructions. The program instructions include mining process logs of different types of prior service requests to extract workflows from the process logs of the prior service requests and saving the extracted workflows of the prior service requests to a library of workflows. The program instructions also include receiving a new service request and, in response to receiving the new service request, providing one or more workflow recommendations based at least in part on one or more of the extracted workflows of the library of workflows. The program instructions then include generating a new workflow for completing the new service request from the one or more workflow recommendations.

According to yet another non-limiting embodiment, a computer program product is provided. The computer program product includes a computer readable storage medium having program instructions embodied therewith, the program instructions executable by a computer processor to cause the computer processor to perform a method for generating workflows in response to service requests. A non-limiting example of the method includes mining process logs of different types of prior service requests to extract workflows from the process logs of the prior service requests. The method also includes saving the extracted workflows of the prior service requests to a library of workflows, wherein the extracted workflows comprise sub-workflows of parameter acquisition, authorization and execution. The method then includes receiving a new service request wherein the new service request is not associated with a process log and, in response to receiving the new service request, providing one or more workflow recommendations based at least in part on one or more of the extracted workflows of the library of workflows. The method then also includes generating a new workflow for completing the new service request from the one or more workflow recommendations.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings, in which:

FIG. 1 is a block diagram illustrating a computer system for submitting and handling service requests for changes in services in accordance with various embodiments of the invention;

FIG. 2 illustrates parameter acquisition sub-workflows of exemplary service requests for changes according to one or more embodiments of the present invention;

FIG. 3 illustrates parameter acquisition sub-workflows for exemplary service requests for changes according to one or more embodiments of the present invention;

FIG. 4 illustrates authentication sub-workflows for exemplary service requests for changes according to one or more embodiments of the present invention;

FIG. 5 illustrates execution sub-workflows for exemplary service requests for changes according to one or more embodiments of the present invention;

FIG. 6 is a flow diagram illustrating a method for generating workflows in response to service requests according to one or more embodiments of the present invention; and

FIG. 7 is a flow diagram illustrating an alternative method for generating workflows in response to service requests according to one or more embodiments of the present invention.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computer systems and specific computer programs to implement the various technical features described herein are well known. Accordingly, in the interest of brevity, many conventional implementation details are only mentioned briefly herein or are omitted entirely without providing the well-known system and/or process details.

In the following detailed description and accompanying drawings, computer systems, computer-implemented methods, and computer program products are described and illustrated for mining process logs of prior computer service requests in response to receiving a new service request. Various technical benefits are achieved using the computer system and methods described herein, including the capability of providing enhanced performance for applications with exclusive access to the co-processors while also allowing applications that do not need performance access to accelerators when shared access is available. In this manner, the computer system can realize performance gains through the use of co-processors in the system, thereby improving overall processing speeds.

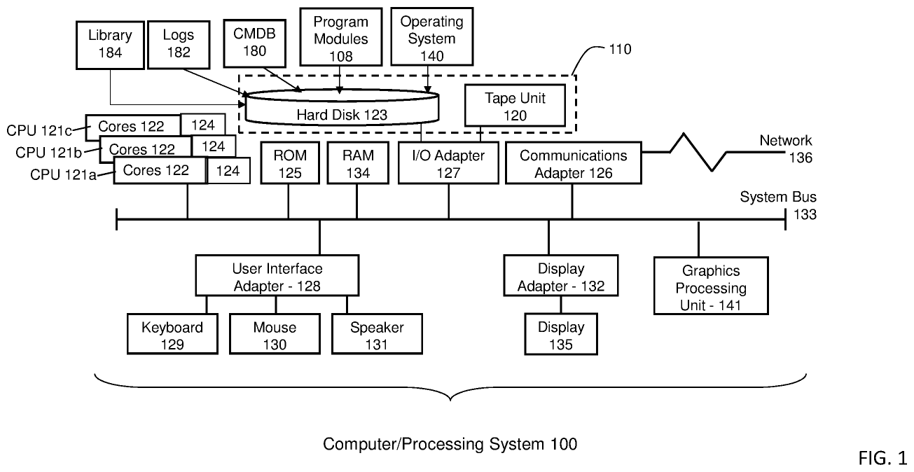

Referring now to FIG. 1, a computer system 100 is illustrated according to a non-limiting embodiment. In FIG. 1 the computer system 100 is shown in the form of a general-purpose computer device which also may be referred to as a processing device. In some embodiments, the computer system 100 may be a management server, a web server, laptop computer, tablet computer, netbook computer, personal computer (PC), a desktop computer, or any programmable electronic device capable of receiving and sending data and processing program instructions.

The components of computer system 100 may include, but are not limited to, one or more central processing units (CPUs) 121a, 121b, 121c, etc. (collectively or generically referred to as processor(s) 121). In one or more embodiments, each processor 121 includes one or more cores 122 and one or more caches 124. There may be any number of cores with each processor 121. Also, each processor 121 may include any number of cache levels operatively connected to one another. Processors 121 are coupled to random access memory (RAM) 134 and various other components via a system bus 133. Read only memory (ROM) 125 is coupled to the system bus 133 and may include a basic input/output system (BIOS), which controls certain basic functions of computer system 100.

Cache 124, for example, may have 1 to N congruence classes (rows) and 1 to N sets (columns) as understood by those skilled in the art. Each congruence class can also be referred to as an addressable index and each set can be referred to as a compartment. Cache 124 has numerous memory elements or cells where each memory element stores data. Cache 124 preferably is a fast memory that enhances the performance of the processor 121 by holding recently accessed data, and data near accessed data, from RAM 134. Although cache 124 is depicted as on-processor cache, one or more caches may be off-processor cache. Data retrieved from RAM 134 may be cached in any of the caches. Typically, the cache size increases as the cache level increases while the speed at which data can be accessed decreases as the cache level increases, primarily because lower level caches are located close to core 122 and/or processor 121. Thus, it should be understood that different cache arrangements, in both number of cache levels and location within the system, are recognized by embodiments of the present invention. Further, some cache levels may be dedicated to a core 122, while other cache levels may be shared between multiple cores 122 of a processor 121.

FIG. 1 further depicts an input/output (I/O) adapter 127 and a network adapter 126 coupled to the system bus 133. I/O adapter 127 may be a small computer system interface (SCSI) adapter that communicates with a hard disk 123 and/or tape storage drive 120 or any other similar component. I/O adapter 127, hard disk 123, and tape storage device 120 are collectively referred to herein as mass storage or system memory 110.

Depending on the configuration and type of computer system 100, system memory 110 includes, but is not limited to, volatile storage (e.g., random access memory), non-volatile storage (e.g., read-only memory), flash memory, or any combination of such memories. According to an aspect, the system memory 110 includes an operating system 140 and one or more program modules 108 for execution by one or more processors 121 via the caches 124. Particularly, the program modules 108 includes computer readable program instructions for carrying out operations according to embodiments of the invention as discussed further herein. Operating system 140 for execution on the processing system 100 may be stored in mass storage/system memory 110. However, the operating system 140 may also be stored in RAM 134 of the computer system 100. Operating systems according to embodiments of the present invention include, for example, UNIX™, Linux™, Microsoft XP™ AIX™ and IBM's i5/OS™.

A network adapter 126 interconnects bus 133 with an outside network 136 enabling the computer system 100 to communicate with other such systems. A screen (e.g., a display monitor) 135 is connected to system bus 133 by display adaptor 132, which may include a graphics adapter to improve the performance of graphics intensive applications and a video controller. In one embodiment, adapters 127, 126, and 132 may be connected to one or more I/O busses that are connected to system bus 133 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 133 via user interface adapter 128 and display adapter 132. A keyboard 129, mouse 130, and speaker 131 all interconnected to bus 133 via user interface adapter 128, which may include, for example, a Super I/O chip integrating multiple device adapters into a single integrated circuit.

In exemplary embodiments, the computer system 100 includes a graphics processing unit 141. Graphics processing unit 141 is a specialized electronic circuit designed to manipulate and alter memory to accelerate the creation of images in a frame buffer intended for output to a display. In general, graphics processing unit 141 is very efficient at manipulating computer graphics and image processing and has a highly parallel structure that makes it more effective than general-purpose CPUs for algorithms where processing of large blocks of data is done in parallel.

Thus, as configured in FIG. 1, the computer system 100 includes processing capability in the form of processors 121, storage capability including RAM 134 and mass storage/system memory 110, input means such as keyboard 129 and mouse 130, and output capability including speaker 131 and display 135. In one embodiment, a portion of RAM 134 and mass storage/system memory 110 collectively store the operating system 140 to coordinate the functions of the various components shown in FIG. 1.

There can be service requests received for changes in an IT environment to correct and complete service requests, and they may be divided into sub-workflows corresponding with parameter acquisition, approval or authentication, and execution. These sub-workflows may sometimes be referred to as capacity determinations. For example, a user provides or submits a service request to the help desk. The help desk then validates the user's service request and routes the service request to the dispatcher to determine who within the IT department is available to handle the service request. The service request is then routed to the subject matter expert (SME) in order to determine whether parameters of the service request are correct or whether modifications should be requested from the user. If the parameters are incorrect, modifications are requested from the user who then modifies the service request. The corrected parameters are then sent back to the SME.

If the parameters are correct or if the parameters have been corrected, the manual authentication sub-workflow can begin. The service request is sent to the change owner to perform technical risk analysis and to the account owner to perform business risk analysis. The authentication sub-workflow concludes when the approver approves the service request and the change owner confirms that the service request may be executed. The executor receives a report from the change owner upon which the service request may be executed.

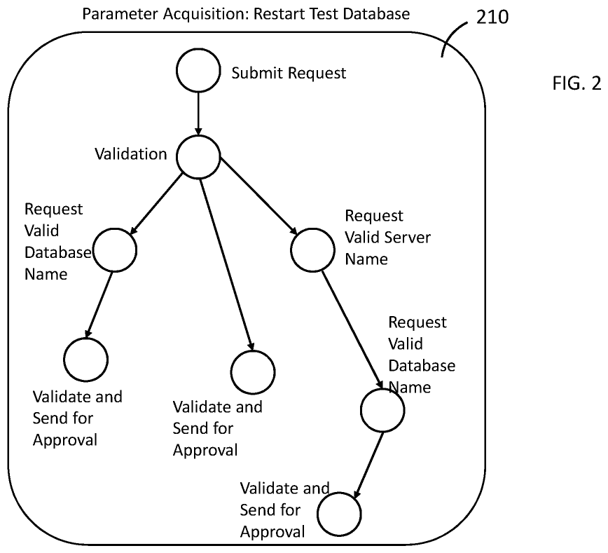

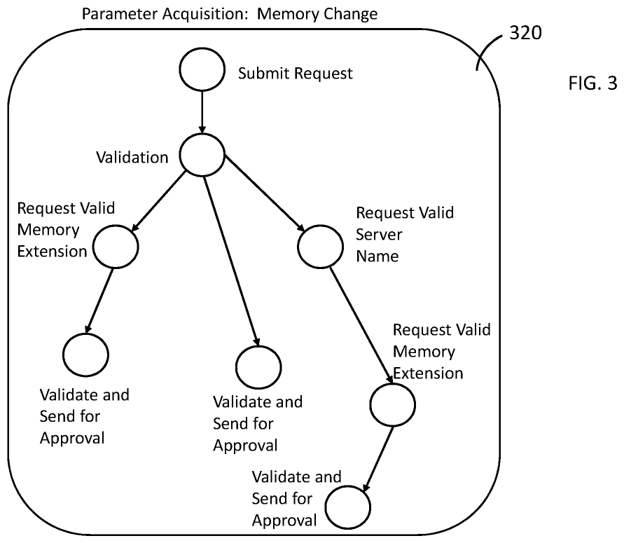

FIGS. 2 and 3 illustrate parameter acquisition sub-workflows of exemplary service requests for changes to an IT environment according to aspects of the invention. The IT environment includes one or more of the computer systems 100 including a configuration management database (CMDB) 180 for documenting configuration items within the one or more computer systems 100. The processing of the service requests depends on how accurate and complete the information is within the service request from the user. Also, one or more of the operations within a particular workflow may have preconditions that have to occur before the service request is approved and/or executed.

For example, as shown in FIG. 2, an exemplary workflow 210 executed by computer system 100 of a service request to restart a test database on a server is depicted as starting at the upper-most node when the user submits the service request and then flowing to the validation step. Parameter validation can be performed via the CMDB 180. If the server name and database name in the service request are both correct, the workflow proceeds along the center branch where the service request is validated and sent for approval. However, if the server name is correct but the database name is missing or incorrect, the workflow proceeds along the left-most branch where a valid database name is requested from the user. Upon receiving a valid database name, the service request is validated and sent for approval. If both the server and database names are missing or incorrect, the workflow proceeds along the right-most workflow branch where both a valid server name and a valid database name are requested from the user. Upon receiving valid server and database names, the service request is validated and sent for approval.

FIG. 3 illustrates an exemplary parameter acquisition workflow 320 of a service request to change memory. For example, a user may want to upgrade from 2 GB to 4 GB. In such case, from receipt of the service request, the workflow proceeds to the validation step to determine if the information from the user is accurate and complete in order to complete the change. If the server name and memory extension in the service request are both correct, the workflow proceeds along the center branch where the service request is validated and sent for approval. However, if the server name is correct but the memory extension is missing or incorrect, the workflow proceeds along the left-most branch where a valid memory extension is requested from the user. Upon receiving a valid memory extension, the service request is validated and sent for approval. If both the server name and memory extension are missing or incorrect, the workflow proceeds along the right-most workflow branch where both a valid server name and a valid memory extension are requested from the user. Upon receiving a valid server name and a valid memory extension, the service request is validated and sent for approval.

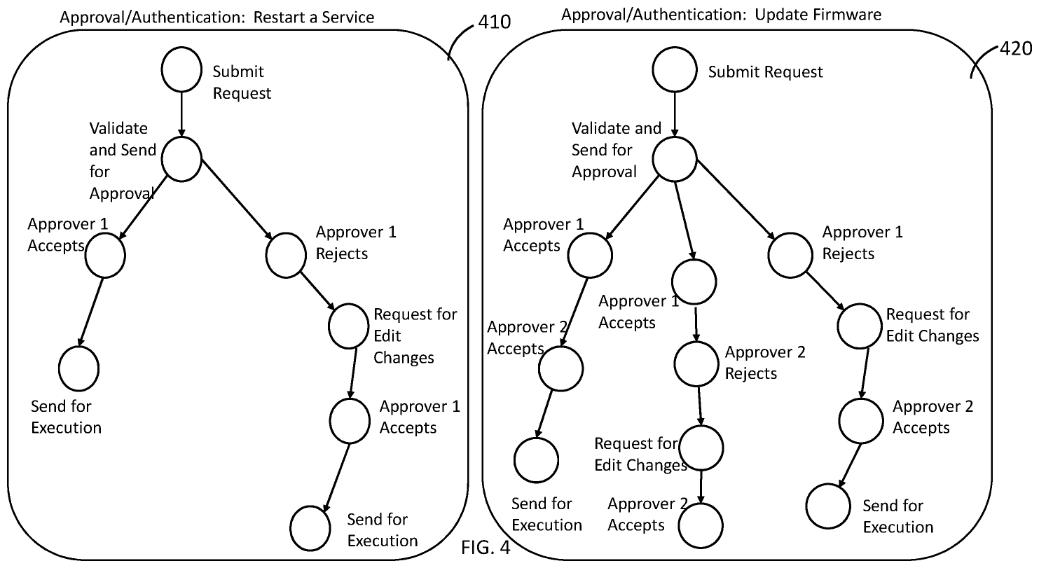

FIG. 4 illustrates approval/authentication sub-workflows for exemplary service requests for changes according to one or more embodiments of the present invention. As shown in workflow 410 executed by computer system 100, upon submission of a service request to restart a service, approval or authentication of the service request may be obtained in as little as one step if edit changes are not required. This is depicted on the left of the workflow 410 where Approver 1 accepts and the service request is sent for execution. However, on the right of workflow 410, if Approver 1 rejects, a request for edit changes is sent. Upon receive the correct edits, Approver 1 then accepts and the service request is sent for execution.

Still referring to FIG. 4, a workflow 420 executed by computer system 100 illustrates authentication of a service request for a change to update firmware for a server which may be performed in as little as two operations with two different approvers. For example, before a server can be updated, it must be determined what applications are running on the server and who owns those applications. If there are two application owners then two different approvers would be required. On the left, if both Approver 1 and Approver 2 accept changes to the firmware of the server, the service request to update the firmware of the server is sent for execution. However, if Approver 1 accepts but Approver 2 does not, the center branch is followed where edit changes are requested. Upon receiving the edits and Approver 2 accepting, the service request is sent for execution. Also, on the right of workflow 420, when Approver 1 rejects, edit changes are requested which Approver 1 and Approver 2 may then accept, so that the service request may then be sent for execution.

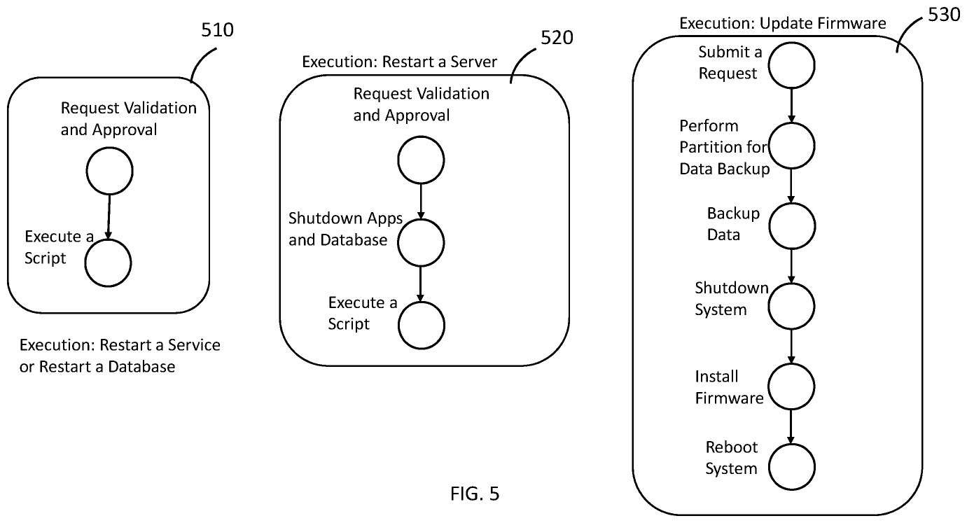

FIG. 5 illustrates execution sub-workflows for exemplary service requests for changes according to one or more embodiments of the present invention. In exemplary execution workflow 510 of FIG. 5 executed by computer system 100, where for example a service request to restart a service or a database has been validated and approved, a script could be executed in order to restart the service or the database. Also, in exemplary execution workflow 520 executed by computer system 100, where a request to restart a server has been validated and approved, multiple operations or actions may be required in order to execute a script to restart the server. For example, it may be necessary to shut down one or more applications or the database. In another exemplary execution workflow 530 executed by computer system 100 of a service request to update firmware on a server, server actions are required prior to changing the firmware pursuant to the change request. As shown in workflow 530, upon submitting the service request, a partition is performed and the data is backed up. The server is then shutdown to install the firmware after which the server is rebooted with the updated firmware.

Thus, the operations and/or events described in association with the parameter acquisition, approval/authentication and execution sub-workflows of the examples of FIGS. 3, 4 and 5, are logged and stored in RAM 134 and mass storage/system memory 110 by computer system 100. The process logs 182 of the prior service requests are mined by program modules 108 of computer system 100 for different types of prior service requests. Particular workflows are extracted by computer system 100 from the process logs 182 in order to generate a knowledge base in the form of a library 184 of workflows, which may be stored in RAM 134 and mass storage/system memory 110. Upon receiving a new service request, particularly those service requests not associated with process logs 182, one or more searching algorithms are launched by computer system 100 to determine similarities between the new service request and one or more of the workflows in the library 184. The search algorithms may be any available search algorithm (e.g., as one or more of the program modules 108) capable of searching the library 184 for one or more workflows with similarities within the operations of the parameter acquisition, approval/authentication and execution sub-workflows that are possibly capable of completing the new service request. In one or more embodiments, in response to receiving the new service request, one or more workflow recommendations are provided by program modules 108 of computer system 100 based on one or more of the extracted workflows of the library 184 of workflow.

For example, the recommendations may identify relationships and similarities between operations needed for the new service request and the operations of one or more sub-workflows of the extracted workflows in the library 184. The recommendations may also include all or part of one or more of the extracted workflows from the library 184 of workflows. Workflows of prior service requests may be grouped by program modules 108 based on detected similarities into a group of recommended workflows for completing the new service request. Also, a new workflow for completing the new service request is generated by program modules 108 computer system 100 based on the one or more workflow recommendations. For example, the new workflow (e.g., generated by program modules 108) for the new service request is flexible in that it is not necessarily a fixed sequence of operations corresponding with a workflow of a prior service request. Thus, the new workflow may include some or all operations of one or more of extracted workflows from the library 184 that correspond with related or similar prior service requested that have been completed. One or more of the related prior service requests may be prior service requests involving the same type of change.

Preferably, one or more operations within the parameter acquisition, the approval/authentication and the execution sub-workflows are automated via the processor 121 of the computer system 100. For example, one or more or all of the operations for providing the one or more workflow recommendations based on the extracted workflows from the library 184 of workflows, generating the new workflow for completing the new service request from the one or more workflow recommendations, and completing the new service request by implementing the requested change, are automated by and implemented in the new workflow generated as described above (by program modules 108 of computer system 100) in response to receiving the new service request.

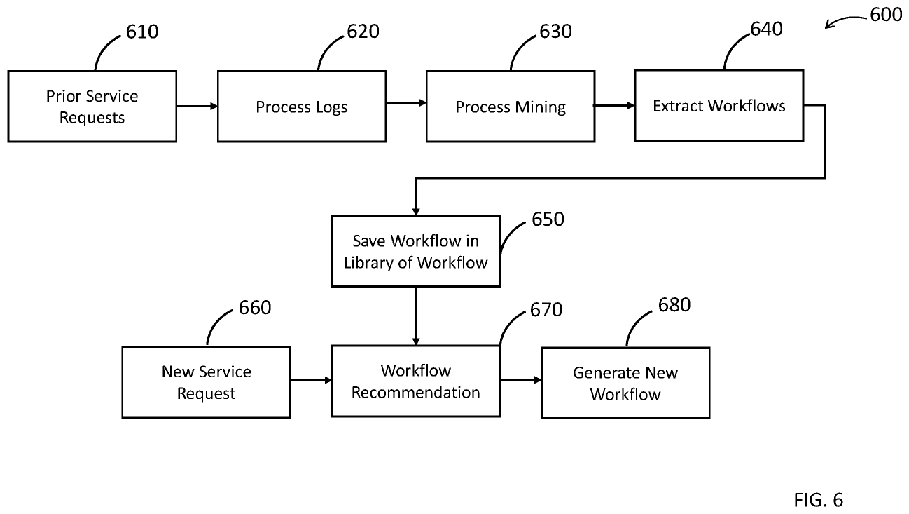

In FIG. 6, a computer-implemented method 600 is illustrated for generating workflows (e.g., a library 184 of workflows) in response to service requests according to a non-limiting embodiment of the invention. All or some of the operations of method 600 may be automated or otherwise performed by program modules 108 of the computer system 100 without manual intervention. The flow diagram of FIG. 6 illustrates the method 600 that includes process blocks 610, 620, 630 and 640 for discovering prior workflows from process logs 182 of prior service requests. In particular, process block 610 includes identifying prior service requests and process block 620 includes identifying the process logs 182 corresponding with the prior service requests. Preferably, the prior services requests include different types of prior service requests. Method 600 then includes process block 630 for mining the process logs 182 of the prior service requests and process block 640 for extracting or generating workflows from the process logs 182 of the prior service requests. Process block 650 of method 600 then includes storing the extracted workflows in a library 184 of workflows.

Still referring to FIG. 6, the method 600 also includes process block 660 for receiving an unknown or new service request that is without process logs 182. At process block 670, because the new service request is without its own process logs 182 from which an appropriate workflow may be extracted or generated, one or more workflow recommendations are generated for the new service request based on one or more of the workflows from the library 184 of workflows. At process block 680, a new workflow is generated for completing the new service request where the new workflow is based on the one or more workflow recommendations. An example scenario is discussed below for explanation purposes. Program modules 108 of the computer system 100 are configured to apply and/or implement the well-known Alpha algorithm for process mining to discover workflows from logs 182. A log 182 might contains multiple traces which means the same trace can occur multiple times. A trace is a sequence of events. The alpha algorithm of program modules 108 can apply, for example, four ordering relations rules to discover ordering relations among the events. First, the alpha algorithm of program modules 108 applies the direct succession rule that determines if an even x is followed by an event y. Second, the alpha algorithm of program modules 108 applies the causality rule that checks if an event x is followed by y, however, y is never followed by x. Third, the alpha algorithm of program modules 108 applies the parallel rule that identifies patterns where x is sometimes followed by y and y is sometimes followed by x. Fourth, the alpha algorithm of program modules 108 applies the choice rules that checks if x is never directly followed by y and y is never directly followed by x. Once the ordering relations are learned by program modules 108 using the four rules, the program modules 108 is configured to construct a set of workflow patterns which are stored in the library 184 of workflows. For example, if the program modules 108 observe a->b (causal relation), then the program modules 108 create a sequential pattern between a and b. Next, if the program modules 108 observe a->b (causal relation), a->c (causal relation), and b#c (choice relation), the program modules 108 create a XOR-split pattern between a, b, and c. If the program modules 108 observe b->d (causal relation), c->d (causal relation), and b#c (choice), then the program modules 108 create XOR-join pattern. If the program modules 108 see a->b (causal relation), a->c (causal relation), and b∥c (parallel relation), the program modules 108 create an AND-split pattern. If the program modules 108 see b->d (causal relation), c->d (causal relation), and b∥c (choice), the program modules 108 create an AND-join pattern. The program modules 108 merge all the patterns learned, i.e., sequential, XOR-split, XOR-join, AND-split, and AND-join to discover/determine the entire workflow for given logs 182, which are stored in the library 184 of workflows for later use. Using the discovered/determined workflow for given logs 182, the program modules 108 matches the unknown or new service request to the discovered/determined workflow (i.e., one of the new workflows that has been generated) in the library 184 of workflows. The program modules 108 execute the discovered/determined new workflow to automatically execute the unknown or new service request.

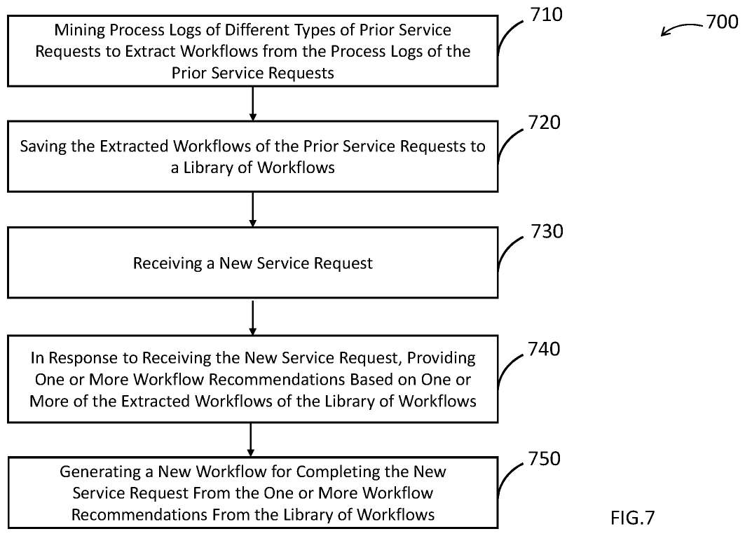

Turning now to FIG. 7, a computer-implemented method 700 for generating workflows (e.g., the library 184 of workflows) in response to service requests is illustrated according to another non-limiting embodiment. All or some of the operations of method 700 may be automated or otherwise performed by program modules 108 of the computer system 100 without manual intervention. The flow diagram of FIG. 7 illustrates the method 700 that includes process block 710 for mining process logs 182 of different types of prior service requests to extract workflows from the process logs 182 of the prior service requests. The method 700 also includes process block 720 for saving the extracted workflows of the prior service requests to the library 184 of workflows and process block 730 for receiving a new service request. The method 700 then includes process block 740 for, in response to receiving the new service request, providing one or more workflow recommendations based on one or more of the extracted workflows of the library 184 of workflows. Method 700 also includes process block 750 for generating a new workflow for completing the new service request from the one or more workflow recommendations.

The computer implemented method 700 may also include one or more other process blocks. In one or more embodiments, the method 700 can include where the new service request is not associated with a process log. The method 700 can also include where each of the extracted workflows comprise sub-workflows of parameter acquisition, authorization and execution. The method 700 also may include where providing one or more workflow recommendations based on one or more of the extracted workflows of the library 184 of workflows comprises providing one or more of the extracted workflows from the library 184 of workflows. The method 700 may include where the new service request is to restart a database, is to change memory, is to restart a server, or is to update firmware on a server. The method 700 can include where providing the one or more workflow recommendations based on one or more of the extracted workflows of the library 184 of workflows and generating the new workflow for completing the new service request from the one or more workflow recommendations is automated in response to receiving the new service request. For a new service request that may not have process logs 182 and/or does not match any of the process logs 182, extraction of workflow may seem challenging. For example, program modules 108 may search and determine that the new service request does not match an existing service request in the process logs 182. Thus, program modules 108 are configured to recommend a workflow for the new service request. For recommendation, the program modules 108 rely on workflow library 184. The recommendation can be performed using the following operations. First, program modules 108 identify service requests from process logs 182 that are related to the new service request. For example, program modules 108 determine the relationship based on similarity of attributes such as nouns and verbs within the new service request to a previous service request in process logs 182. To determine the relationship based on similarity of attributes, the program modules 108 can parse the previous service requests in process logs 182 to find matching keywords and/or terms in the new service request. For example, a service request “restart a service” is similar to “restart a database” or “restart a server” in considering that the verbs are similar. Second, based on the similarity found in process logs 182, program modules 108 extract (corresponding) worklogs from library 184 for the similar service requests found in the process logs 182, in which these extracted worklogs from library 184 are utilized to perform the similar service requests. To narrow down the results of extracted worklogs from library 184, program modules 108 compare attributes of the new service request with the attributes of extracted workflows from library 184. For example, “restart a service” has two attributes: “service name” and “server name”, “restart database” has three attributes: “database name”, “database instance name” and “server name”, and “restart server” has only one attribute: “server name”. Based on a determination and comparison by program modules 108 that the attributes of “restart service” are more similar to “restart database” rather than “restart server”, the program modules 108 determine that the workflow in library 184 for “restart database” is relevant to “restart service” and/or has matching attributes. Accordingly, the program modules 108 recommend this relevant/selected workflow having the matching attributes to the new service request. Therefore, by using relevant/selected workflow having the matching attributes to the new service request, program modules 108 have selected workflow among the workflows in library 184 to recommend as the workflow that best fits the new service request. The program modules 108 can execute this recommended workflow to automatically execute the new service request. Further, it should be appreciated that blocks in FIGS. 6 and 7 can be integrated and substituted as understood by one skilled in the art.

Thus, it can be seen from the foregoing detailed description and accompanying illustrations that various technical benefits are achieved using the systems and methods described herein, including the capability of providing enhanced performance for applications with exclusive access to the co-processors while also allowing applications that do not need performance access to accelerators when shared access is available. In this manner, the computer system can realize performance gains through the use of co-processors in the system, thereby improving overall processing speeds.

The present invention may be a system, a computer implemented method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for generating workflows in response to service requests, the computer-implemented method comprising:
mining process logs of different types of prior service requests to extract workflows from the process logs of the prior service requests;
saving the extracted workflows of the prior service requests to a library of workflows;
receiving a new service request;
in response to receiving the new service request, providing one or more workflow recommendations based at least in part on one or more of the extracted workflows of the library of workflows; and
generating a new workflow for completing the new service request from the one or more workflow recommendations.

2. The computer-implemented method of claim 1, further comprising executing the new workflow to complete the new service request.

3. The computer-implemented method of claim 1, wherein each of the extracted workflows comprise sub-workflows of parameter acquisition, authorization and execution.

4. The computer-implemented method of claim 1, wherein providing the one or more workflow recommendations based on one or more of the extracted workflows of the library of workflows comprises providing one or more of the extracted workflows from the library of workflows.

5. The computer-implemented method of claim 1, further comprising determining that the new service request does not match any of the process logs of the different types of the prior service requests.

6. The computer-implemented method of claim 5, further comprising determining at least one service request of the prior service requests that has terms related to the new service request.

7. The computer-implemented method of claim 6, further comprising identifying the extracted workflows of the library of workflows that are utilized to perform the at least one service request; and
selecting at least one of the extracted workflows having matching attributes to the new service request.

8. The computer-implemented method of claim 7, wherein the one or more workflow recommendations corresponds to the at least one of the extracted workflows having the matching attributes to the new service request.

9. The computer-implemented method of claim 1, wherein providing the one or more workflow recommendations based at least in part on one or more of the extracted workflows of the library of workflows and generating the new workflow for completing the new service request from the one or more workflow recommendations is automated in response to receiving the new service request.

10. A computer system for generating workflows in response to service requests, the computer system comprising:
a processor communicatively coupled to a memory unit, wherein the processor is configured to execute program instructions comprising:
mining process logs of different types of prior service requests to extract workflows from the process logs of the prior service requests;
saving the extracted workflows of the prior service requests to a library of workflows;
receiving a new service request;
in response to receiving the new service request, providing one or more workflow recommendations based at least in part on one or more of the extracted workflows of the library of workflows; and
generating a new workflow for completing the new service request from the one or more workflow recommendations.

11. The computer system of claim 10, further comprising executing the new workflow to complete the new service request.

12. The computer system of claim 10, wherein the extracted workflows comprise sub-workflows of parameter acquisition, authorization and execution.

13. The computer system of claim 10, wherein providing the one or more workflow recommendations based at least in part on one or more of the extracted workflows of the library of workflows comprises providing one or more of the extracted workflows from the library of workflows.

14. The computer system of claim 10, further comprising determining that the new service request does not match any of the process logs of the different types of the prior service requests.

15. The computer system of claim 14, further comprising determining at least one service request of the prior service requests that has terms related to the new service request.

16. The computer system of claim 15, further comprising identifying the extracted workflows of the library of workflows that are utilized to perform the at least one service request; and
selecting at least one of the extracted workflows having matching attributes to the new service request.

17. The computer system of claim 16, wherein the one or more workflow recommendations corresponds to the at least one of the extracted workflows having the matching attributes to the new service request.

18. A computer program product comprising a computer readable storage medium having program instructions embodied therewith, the program instructions executable by a computer processor to cause the computer processor to perform a method for generating workflows in response to service requests, the method comprising:
mining process logs of different types of prior service requests to extract workflows from the process logs of the prior service requests;
saving the extracted workflows of the prior service requests to a library of workflows, wherein the extracted workflows comprise sub-workflows of parameter acquisition, authorization and execution;
receiving a new service request, wherein the new service request is not associated with a process log;
in response to receiving the new service request, providing one or more workflow recommendations based at least in part on one or more of the extracted workflows of the library of workflows; and
generating a new workflow for completing the new service request from the one or more workflow recommendations.

19. The computer program product of claim 18, further comprising:
determining that the new service request does not match any of the process logs of the different types of the prior service requests;
determining at least one service request of the prior service requests that has terms related to the new service request;
identifying the extracted workflows of the library of workflows that are utilized to perform the at least one service request; and
selecting at least one of the extracted workflows having matching attributes to the new service request, wherein the one or more workflow recommendations corresponds to the at least one of the extracted workflows having the matching attributes to the new service request.

20. The computer program product of claim 18, wherein providing the one or more workflow recommendations based at least in part on one or more of the extracted workflows of the library of workflows and generating the new workflow for completing the new service request from the one or more workflow recommendations is automated in response to receiving the new service request.
